(19) United States
(12) Patent Application Publication
(10) Pub. No.: US 2026/0057433 A1
(43) Pub. Date: Feb. 26, 2026

(54) SYSTEM AND METHODS FOR RECOMMENDING PHYSICAL BOOKS

(71) Applicant: Laguna 72, LLC, Spirit Lake, IA (US)

(72) Inventor: Charles Arthur Long, Spirit Lake, IA (US)

(21) Appl. No.: 19/307,718

(22) Filed: Aug. 22, 2025

Related U.S. Application Data
(60) Provisional application No. 63/686,403, filed on Aug. 23, 2024.

(51) Int. Cl. G06Q 30/0601

(52) U.S. Cl. CPC G06Q 30/06311

(57) ABSTRACT

A system and method are provided for recommending physical books to a user based on images captured by a camera. One or more processors control the camera to capture images of a plurality of physical books, perform image analysis to identify each book, and access a reader preference profile of the user. The system determines a recommendation score for each book based at least in part on the reader preference profile, identifies the book with the highest recommendation score, and generates a graphical user interface including a graphical indication of the recommended book. The graphical user interface is then output to an output component, enabling the user to quickly and effectively select a physical book from a limited set of options.

### RELATED APPLICATIONS

This application claims the benefit of U.S. Provisional Application No. 63/686,403, filed Aug. 23, 2024, the entire contents of which are incorporated herein by reference.

### TECHNICAL FIELD

The disclosure relates to a system for identifying and recommending physical books in the vicinity of a user.

### BACKGROUND OF THE INVENTION

In recent years, computing systems that facilitate personalized recommendations for reading materials have seen widespread adoption in digital marketplaces and e-reader platforms. These systems leverage advances in data processing, user profiling, and network connectivity to present users with selections drawn from vast online catalogs. While much of the focus has been on virtual or downloadable content, none of these capabilities extend to tangible, physical books encountered in everyday settings.

Users often seek guidance when faced with unfamiliar selections of physical books, whether in small retail outlets, public libraries, or nontraditional venues like travel hubs. The goal of such guidance is to help individuals rapidly identify a book that aligns with their tastes, current reading objectives, and constraints on time or budget. This contextual awareness plays a significant role in providing meaningful recommendations when the pool of available titles is limited.

Despite the abundance of sophisticated recommendation engines for online catalogs, existing solutions exhibit limitations when applied to in-person book selection scenarios. Conventional platforms are optimized to search and rank millions of titles but are not designed to operate on a curated subset of books present on a shelf or display. When a user needs a prompt suggestion from a handful of available volumes, universally scoped recommendation algorithms can become computationally inefficient and may overlook the important restriction that only certain items are immediately obtainable. Moreover, the manual effort required to enter or browse through metadata for each book can introduce friction that undermines rapid decision-making.

In many real-world environments, such as airport kiosks, boutique bookstores, and community reading events, individuals have only moments to choose a book and may lack the luxury of detailed browsing. The challenge lies in delivering streamlined, preference-driven recommendations tailored to a small, visible selection of physical titles. Current approaches typically require extensive background processing or rely on remote database queries, neither of which addresses the need for swift guidance under tight time constraints.

### SUMMARY OF THE INVENTION

In general, the disclosure is directed to an artificial intelligence system that is capable of identifying physical books depicted in one or more images captured by a camera. After identifying the physical books from the image, the artificial intelligence system is capable of utilizing a reader preference profile to determine which of that limited set of books would be the physical book most likely to be enjoyed by the reader. The artificial intelligence system can output this recommendation, guiding the user quickly and effectively to the best book for them when there is a limited selection of books to choose from.

These techniques provide a number of benefits over existing technologies. While recommendation engines exist, these recommendation engines typically recommend books from a database consisting every book commercially available for purchase at any number of internet marketplaces, or even books unavailable for sale but that are included in their database. A system that provides such universal recommendations is ineffective and rendered useless when dealing with a small subset of that universe of books and when a user has a limited time to determine which book in that small subset is the best book for that particular user. Determining which book from a universe of books may very well not answer the question of which book a user should purchase from a bookstore, and making recommendations from a universe of books is extremely inefficient for computer processors for the task of determining recommendations from a small subset of options. By limiting the analysis to only the books in the image captured by the user, the claimed techniques are improving the computing environment in which the analysis is occurring by greatly reducing the extraneous processing power taken by analyzing books that are not available to the user at the current time. Furthermore, the techniques described herein include cameras and physical books, which are both integral to the process, and not typical computer parts, thereby providing additional practical applications.

In one example, the disclosure is directed to a method in which one or more processors of a computing device control a camera to capture one or more images of a plurality of physical books. The method further includes performing, by the one or more processors, image analysis on the one or more images to identify each of the plurality of physical books. The method also includes accessing, by the one or more processors, a reader preference profile of a user of the computing device. The method further includes determining, by the one or more processors and based at least in part on the reader preference profile, a recommendation score for each of the plurality of physical books. The method also includes determining, by the one or more processors, a first physical book of the plurality of physical books that has a highest recommendation score compared to each other recommendation score for each other physical book of the plurality of physical books. The method further includes generating, by the one or more processors, a graphical user interface including at least a graphical indication of the first physical book. The method also includes outputting, by the one or more processors and to an output component, the graphical user interface.

In one example of this disclosure, a system is provided comprising one or more processors, a camera operably coupled to the processors and configured to capture one or more images of a plurality of physical books, and a memory storing instructions that, when executed by the processors, cause the system to: perform image analysis on the images to identify each of the physical books; access a reader preference profile of a user; determine, based at least in part on the reader preference profile, a recommendation score for each physical book; determine a first physical book having the highest recommendation score among the plurality of physical books; generate a graphical user interface including a graphical indication of the first physical book; and output the graphical user interface to an output component.

In another example of this disclosure, a non-transitory computer-readable storage medium is provided having instructions stored thereon that, when executed by one or more processors of a computing device, cause the computing device to: control a camera to capture one or more images of a plurality of physical books; perform image analysis on the images to identify each of the physical books; access a reader preference profile of a user; determine, based at least in part on the reader preference profile, a recommendation score for each physical book; determine a first physical book having the highest recommendation score among the plurality of physical books; generate a graphical user interface including a graphical indication of the first physical book; and output the graphical user interface to an output component.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating an environment that includes a group of physical books and a computing device configured to analyze and recommend the group of physical books, in accordance with one or more techniques of this disclosure.

FIG. 2 is a block diagram illustrating a more detailed example of a computing device configured to perform the techniques described herein.

FIG. 3 is a flow diagram illustrating an example method for identifying, analyzing, and recommending one of a group of physical books, in accordance with one or more techniques of this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

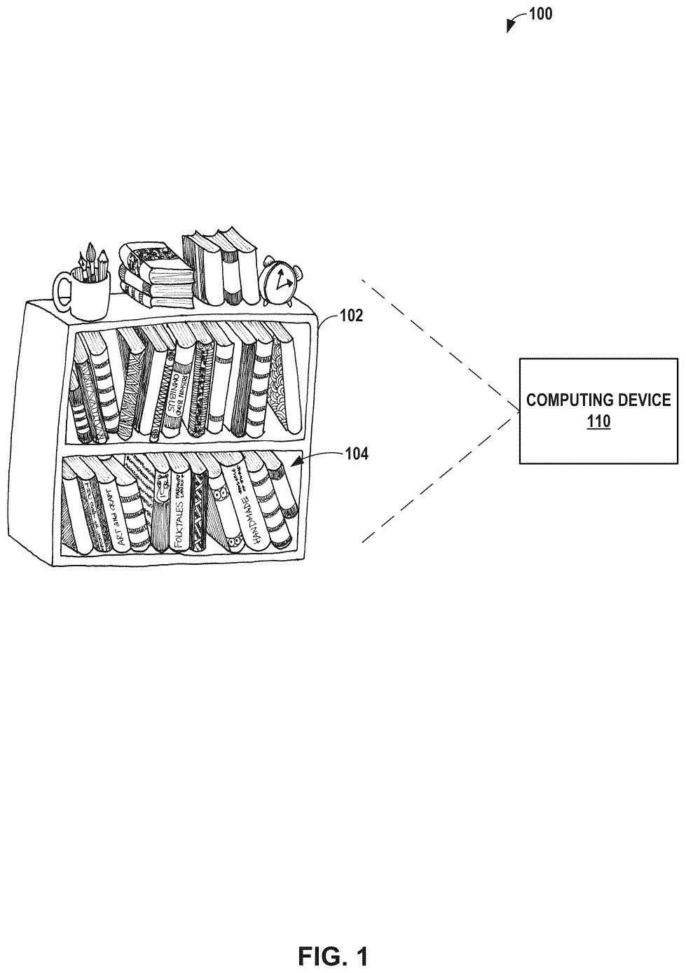

FIG. 1 is a conceptual diagram illustrating an environment 100 that includes bookcase 102 holding physical books 104 and computing device 110. The environment 100 represents the physical and contextual setting in which the book recommendation system operates. This environment may include any location where physical books 104 are stored, displayed, or made available for selection by a user. Examples of such environments include bookstores, libraries, personal homes, offices, airports, or any other location where books are arranged for browsing. The environment 100 serves as the space that includes the bookcase 102, the physical books 104, and the computing device 110. The interaction between these components within the environment 100 facilitates the implementation of the techniques described, such as capturing images of books, analyzing their characteristics, and generating personalized recommendations.

The bookcase 102 is a physical structure within the environment 100 that holds and organizes the physical books 104. The bookcase 102 may be constructed from various materials, such as wood, metal, or plastic, and may include multiple shelves or compartments for arranging books in a systematic manner. The bookcase 102 provides a stable and accessible platform for displaying the physical books 104, enabling the computing device 110 to capture images of the books for analysis. The arrangement of books on the bookcase 102 may vary, including vertical stacking, horizontal stacking, or a combination thereof. The bookcase 102 may also include additional items, such as decorative objects or personal belongings, which the computing device 110 may need to distinguish from the physical books 104 during image analysis.

The physical books 104 are tangible, printed media stored on the bookcase 102 within the environment 100. These books may include a wide variety of genres and formats, such as novels, biographies, textbooks, comic books, cookbooks, and more. Each physical book 104 possesses distinguishing characteristics, such as the title, author, cover design, spine text, dimensions, and other bibliographic details, which can be used for identification and recommendation purposes. The physical books 104 are the primary objects of interest in the system, as the computing device 110 captures images of these books and performs image analysis to identify them. The physical books 104 may also include metadata, such as barcodes or QR codes, which can be utilized by the computing device 110 to enhance the identification process.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

The computing device 110 captures images of the physical books 104 on the bookcase 102, processes these images to identify the books, and accesses a reader preference profile to determine personalized recommendation scores for the books. The computing device 110 may include various hardware and software components, such as processors, memory, communication modules, and graphical user interfaces, to facilitate these operations. The computing device 110 outputs the recommendations to the user via a display or other output components, enabling the user to make informed decisions about which book to select.

In general, the disclosure is directed to an artificial intelligence system that is capable of identifying physical books depicted in one or more images captured by a camera. After identifying the physical books from the image, the artificial intelligence system is capable of utilizing a reader preference profile to determine which of that limited set of books would be the physical book most likely to be enjoyed by the reader. The artificial intelligence system can output this recommendation, guiding the user quickly and effectively to the best book for them when there is a limited selection of books to choose from.

As used herein, “capturing one or more images” refers to any process by which visual data of physical books is obtained by a camera or imaging component of a computing device. This includes, but is not limited to capturing a still image, capturing one or more frames within a video sequence, or completing a scan of objects present in an image preview interface on the computing device, such as by utilizing a live camera feed, panoramic sweep, or other scanning modality that enables identification of physical books within the field of view.

These techniques provide a number of benefits over existing technologies. While recommendation engines exist, these recommendation engines typically recommend books from a database consisting every book commercially available for purchase at any number of internet marketplaces, or even books unavailable for sale but that are included in their database. A system that provides such universal recommendations is ineffective and rendered useless when dealing with a small subset of that universe of books and when a user has a limited time to determine which book in that small subset is the best book for that particular user. Determining which book from a universe of books may very well not answer the question of which book a user should purchase from a bookstore, and making recommendations from a universe of books is extremely inefficient for computer processors for the task of determining recommendations from a small subset of options. By limiting the analysis to only the books in the image captured by the user, the claimed techniques are improving the computing environment in which the analysis is occurring by greatly reducing the extraneous processing power taken by analyzing books that are not available to the user at the current time. Furthermore, the techniques described herein include cameras and physical books, which are both integral to the process, and not typical computer parts, thereby providing additional practical applications.

In accordance with the techniques of this disclosure, computing device 110 may control a camera to capture one or more images of a plurality of physical books 104. Computing device 110 may perform image analysis on the one or more images to identify each of the plurality of physical books. Computing device 110 may access a reader preference profile of a user of the computing device. Computing device 110 may determine, based at least in part on the reader preference profile, a recommendation score for each of the plurality of physical books. Computing device 110 may determine a first physical book of the plurality of physical books that has a highest recommendation score compared to each other recommendation score for each other physical book of the plurality of physical books. Computing device 110 may generate a graphical user interface including at least a graphical indication of the first physical book. Computing device 110 may output, to an output component, the graphical user interface.

As used herein, “camera” refers to any imaging component or sensor capable of capturing visual data, including but not limited to digital cameras, smartphone cameras, webcams, document scanners, wearable cameras, or any other device or module capable of acquiring images or video frames.

As used herein, “reader preference profile” refers to any collection of data, attributes, or metadata that characterizes a user's reading interests, preferences, history, demographic information, emotional triggers, or any other information relevant to generating personalized book recommendations. In the broadest sense, the “reader preference profile” could simply be an affirmative declaration or verification that the user is a human, and the system's recommendations could be based on recommendations made to human users.

As used herein, “recommendation score” refers to any quantitative or qualitative value, metric, or ranking generated by the system that reflects the degree to which a particular physical book matches the reader preference profile or is predicted to be of interest to the user.

As used herein, “graphical user interface” (GUI) refers to any visual display or interface presented to the user by the computing device, including but not limited to screens, touch displays, augmented reality overlays, virtual reality environments, or any other modality for visually presenting information and receiving user input.

As used herein, “output component” refers to any hardware or software element of the computing device capable of presenting information to the user, including but not limited to display screens, speakers, haptic feedback devices, projectors, or any other modality for outputting data.

As used herein, “artificial intelligence model” refers to any algorithm, neural network, machine learning model, or computational technique capable of performing image analysis, pattern recognition, data classification, or any other intelligent processing relevant to the identification and recommendation of physical books.

As used herein, “image analysis” refers to any process or technique by which visual data is processed to identify, classify, or extract information about physical books, including but not limited to optical character recognition (OCR), object detection, image matching, barcode scanning, or any other computational method for analyzing images or video frames.

The AI-powered bookshelf scanning tool is a unique tool for the techniques described herein, in addition to the AI-powered information and personal recommendations. While running this application, users scan an entire bookshelf. The computing device may utilize AI to reads the spines and covers of the books, utilizing various tools (e.g., optical character recognition, image matching tools for covers or spines of the books, barcodes, etc.) to find a match for each book in the scan. In some simple cases, the computing device may sort the books by external reviews (e.g., Google Books®, Goodreads®, Amazon®, etc.). In other instances, other characteristics could be used to sort the books, such as age, price, length, popularity by sales, or other characteristics of the book. In still other instances, the computing device may access a reader preference profile indicative of other books the user has liked in the past and may sort the books based on a recommendation score determined based on the book characteristics and the reader preference profile.

By clicking on a specific book from this list, users can find specific information like written reviews, word count, summary, and sales trends. Before or after scanning, AI could also ask the user what they are specifically looking for. For example, a user who just scanned a shelf of various business books would answer: “I'm an experienced entrepreneur looking to expand my business. I need to learn about securing funding and handling risk.” They could also decline the question if they do not have something specific in mind, or other instances may not prompt the user for any questions prior to providing recommendations. AI would then determine which of the scanned books fits the user's needs or reader preference profile the most. This may include providing a few specific suggestions or by ranking the scanned books.

AI could also ask app users to rank or score which qualities are most important to them (e.g., price, external reviews, internal reviews, sales popularity, length, etc). The app could continue building itself based on a profile-based model. The more books a user reads, the more that AI learns what the user enjoys, what the user is looking for, and which books to suggest.

Users may upload or select which books they have read (even before downloading the application) and give personal reviews. These reviews could accumulate for the app-based internal rating, but also work on an individual level by user.

The app could also track what your friends (or maybe even people near your area or with shared interests) have been enjoying the most recently as well.

The application may utilize AI in a number of different ways, including:
Using the camera to scan the bookshelf to detect books
Asking users to explain what they are looking for specifically before, during, or after the scan is complete
Sorting books according to what the user is specifically looking for
Determining recommendation scores
Sorting books according to respective categories (like price, reviews, page count, age, recommendation scores, etc.)
During sorting, applying weighted values based on what is most or least important to app users
Sourcing information about the book when users click on a specific book (including price, summary, written reviews, etc.)
Providing prices of scanned books elsewhere (including online, other stores, e-books, etc.)
Providing book recommendations other than those that were scanned
Building profiles to understand what the user enjoys and is most accurately looking for
Recognizing book buying patterns based on location, demographics, peer groups, etc.

The problem addressed by the present system lies in the inefficiency and impracticality of existing book recommendation systems when applied to real-world scenarios involving physical books. Traditional recommendation engines are designed to operate on vast databases containing a comprehensive range of commercially available books, often including books that are not immediately accessible to the user. While these systems perform well for online marketplaces or digital libraries, they fail to meet the needs of users in environments with a limited selection of physical books, such as airport bookstores, libraries, or small retail shops. In such scenarios, users are constrained by both the physical availability of books and the limited time they have to make a selection. Existing systems are not optimized to provide recommendations tailored to a small subset of books in the user's immediate vicinity, leading to inefficiencies in both user experience and computational resource utilization.

The concept described herein addresses these limitations by introducing a system and method that leverages artificial intelligence (AI) to identify and recommend physical books from a localized selection. The described approach employs a camera-controlled computing device to capture images of physical books in the user's vicinity. Through advanced image analysis techniques, such as optical character recognition (OCR) and image matching, the system identifies the books depicted in the images. The system then accesses a reader preference profile, which may include detailed user-specific attributes such as genre preferences, emotional triggers, and prior reading history. Using this profile, the system calculates a recommendation score for each identified book, ranking them based on their likelihood of aligning with the user's preferences.

This approach provides several notable improvements over conventional systems. By limiting the analysis to books physically present in the user's environment, the described system significantly reduces the computational overhead associated with processing a universal database of books. This localized focus not only enhances processing efficiency but also ensures that the recommendations are immediately actionable for the user. Additionally, the integration of AI models allows for highly personalized recommendations, taking into account nuanced factors such as emotional triggers, narrative preferences, and contextual user inputs. For example, the system can dynamically adjust recommendation scores to deprioritize books containing content that may elicit an adverse emotional reaction, based on the user's specified triggers.

The solution further enhances user experience through an intuitive graphical user interface (GUI) that visually presents the top-ranked book or a sorted list of recommendations. Users can interact with the GUI to explore additional details about the recommended books, such as summaries, reviews, and pricing information. The system also incorporates feedback mechanisms, enabling users to refine their preference profiles over time, thereby improving the accuracy of future recommendations. By combining specialized AI algorithms, real-time image analysis, and a user-centric design, the described system addresses the shortcomings of prior systems and provides a practical, efficient, and personalized solution for recommending physical books in constrained environments.

The subject matter described herein is directed to a practical application of computer technology that provides a technical solution to a real-world problem, namely, the efficient identification and recommendation of physical books from a limited selection in a user's immediate environment. These system and methods recite specific technological improvements in the field of computer-implemented recommendation systems.

The techniques described herein leverage a combination of hardware components (such as a camera and computing device) and specialized software modules (including artificial intelligence models for image analysis and recommendation scoring) to perform operations that cannot be accomplished solely by human activity or generic computer implementation. For example, the system utilizes image analysis techniques to identify physical books from captured images, accesses and processes a reader preference profile, and generates a graphical user interface with personalized recommendations, all in real time and based on the actual physical context of the user.

These features result in improvements to the functioning of the computing device itself, such as reducing unnecessary processing by limiting analysis to only those books physically present, and enhancing user interaction through context-aware recommendations and dynamic graphical interfaces. The system's ability to process visual data, apply AI models, and output actionable recommendations in a constrained environment demonstrates a specific and concrete technological advancement.

By limiting analysis to only the physical books present in the captured images, the system avoids the need to process and search through vast, universal databases of books. This targeted approach reduces computational overhead, memory usage, and network bandwidth requirements, resulting in faster operation and lower power consumption.

The integration of advanced image analysis techniques, such as optical character recognition (OCR), image matching, and artificial intelligence models, enables the computing device to accurately identify physical books from images or video frames. This expands the device's ability to interpret and act upon real-world visual data, going beyond basic image capture to intelligent object recognition and classification.

The system accesses and utilizes a reader preference profile that may include detailed user attributes, emotional triggers, and historical data. By dynamically adjusting recommendation scores based on this profile and the actual set of available books, the device delivers highly personalized and contextually relevant recommendations, improving the quality and usefulness of its outputs.

These techniques enable the computing device to provide immediate, actionable recommendations in environments where time is limited and the selection of books is constrained. This real-time capability enhances the device's responsiveness and utility in practical scenarios, such as retail stores, libraries, or travel hubs.

The generation of a graphical user interface (GUI) that visually presents recommended books, sorted lists, and additional book details (such as summaries, reviews, and pricing) enhances the device's ability to communicate information to the user. Interactive features, such as prompts for user input and feedback mechanisms, further improve the device's usability and adaptability.

By incorporating mechanisms for receiving user feedback and updating the reader preference profile, the system enables the computing device to learn from user interactions and refine future recommendations. This adaptive functionality leads to continuous improvement in recommendation accuracy and device performance over time.

The system can identify and flag books containing content that may elicit adverse emotional reactions based on user-specified triggers. This capability not only personalizes recommendations but also enhances the device's sensitivity to user well-being, providing a safer and more considerate user experience.

The techniques are implemented through modular software and hardware components, such as communication modules, analysis modules, and storage components. This architecture allows for scalability, easy integration with other systems, and flexible deployment across a wide range of computing devices.

The system supports multiple output modalities, including visual, auditory, and haptic notifications, allowing the computing device to deliver recommendations in the most effective format for the user's context and preferences.

By automating the identification and recommendation process, the system reduces the need for manual data entry or browsing, streamlining the user's experience and minimizing friction in decision-making.

Collectively, these improvements result in a computing device that is more efficient, intelligent, responsive, and user-centric, providing technical benefits that go beyond generic computer implementation and directly address the challenges of recommending physical books in real-world environments.

Accordingly, the techniques described herein are directed to a technological solution rooted in computer technology, provides improvements to computer functionality, and applies concepts in a manner that is integrated into a practical application. The techniques described herein include a specific arrangement of components and processes that solve a problem unique to the field of physical book recommendation in real-world settings.

The techniques described herein center on a system and method for efficiently identifying and recommending physical books to a user based on images captured in real-world environments. Unlike conventional recommendation engines that operate on vast, universal databases, the disclosed techniques leverage a computing device equipped with a camera and artificial intelligence models to analyze only those physical books present in the user's immediate vicinity. The system performs image analysis to identify the available books, accesses a detailed reader preference profile, and calculates personalized recommendation scores for each book. By focusing exclusively on the subset of books physically accessible to the user, the system dramatically reduces computational overhead and delivers contextually relevant, actionable recommendations in real time.

Further, the techniques described herein incorporate advanced personalization features, such as emotional trigger detection and dynamic adjustment of recommendation scores, as well as interactive graphical user interfaces that present sorted lists and detailed book information. The system also enables adaptive learning by updating the reader preference profile based on user feedback, thereby continuously improving recommendation accuracy. This combination of localized image analysis, AI-driven personalization, and real-time user interaction represents a significant advancement over prior systems, providing a practical, efficient, and user-centric solution for selecting physical books in constrained environments.

In one example, consider a traveler that arrives at an airport bookstore with only a few minutes before their flight departs. The bookstore offers a limited selection of physical books displayed on several shelves. The traveler wants to quickly find a book that matches their interests and current mood, but does not have time to browse through each title or read reviews.

Using their smartphone, the traveler opens a book recommendation app powered by the disclosed system. The app prompts the traveler to scan the bookshelf by pointing the phone's camera at the shelves. The app captures several images and, using artificial intelligence and image analysis, identifies the titles and authors of all visible physical books.

The app then asks the traveler a few quick questions—such as what genre they are interested in, whether they want to avoid certain topics (e.g., violence or tragedy), and if they have any specific preferences (e.g., length, price, or recent bestsellers). The traveler's responses, combined with their historical reading data stored in the app, are used to update their reader preference profile.

Within seconds, the app calculates a recommendation score for each identified book, taking into account the traveler's preferences and any emotional triggers. The app generates a graphical user interface displaying the top recommended book, along with a sorted list of other suitable options. Each book entry includes a summary, external reviews, price, and any relevant trigger warnings.

The traveler selects the top recommendation and reviews the details. Satisfied, they purchase the book and board their flight. After reading, the traveler provides feedback in the app, which further refines their preference profile for future recommendations.

This implementation demonstrates how the system enables users to efficiently and confidently select a physical book from a limited set of options, leveraging real-time image analysis, personalized AI-driven recommendations, and an intuitive user interface all within the constraints of a fast-paced, real-world environment.

In another example, a college student visits a local library to find a new book to read over the weekend. The library has a small display of recently acquired physical books. The student wants to avoid books containing themes of violence due to personal sensitivity, which is reflected in their reader preference profile stored in a book recommendation app on their tablet.

The student opens the app and uses the tablet's camera to scan the display shelf. The app captures images of the books and, using artificial intelligence and image analysis, identifies the titles and authors of all the physical books present.

The app accesses the student's reader preference profile, which includes a trigger warning for violence. As the app calculates recommendation scores for each identified book, it analyzes available metadata, summaries, and reviews to detect the presence of violent themes. One of the books, a popular thriller, contains scenes of violence as indicated in its description and external reviews.

Recognizing the match with the student's trigger warning, the app automatically lowers the recommendation score for the thriller and flags it with a graphical trigger warning in the user interface. The app then generates a sorted list of recommended books, excluding the thriller from the top suggestions and visually indicating the reason for its deprioritization.

The student reviews the recommendations and selects a mystery novel that does not contain violent content. The app provides a summary, reviews, and price information for the selected book. The student checks out the book and later provides feedback in the app, which further refines their profile for future recommendations.

This scenario illustrates how the system proactively filters out books that may elicit an adverse emotional reaction based on the user's trigger warnings, ensuring that recommendations are not only personalized but also sensitive to the user's well-being and preferences.

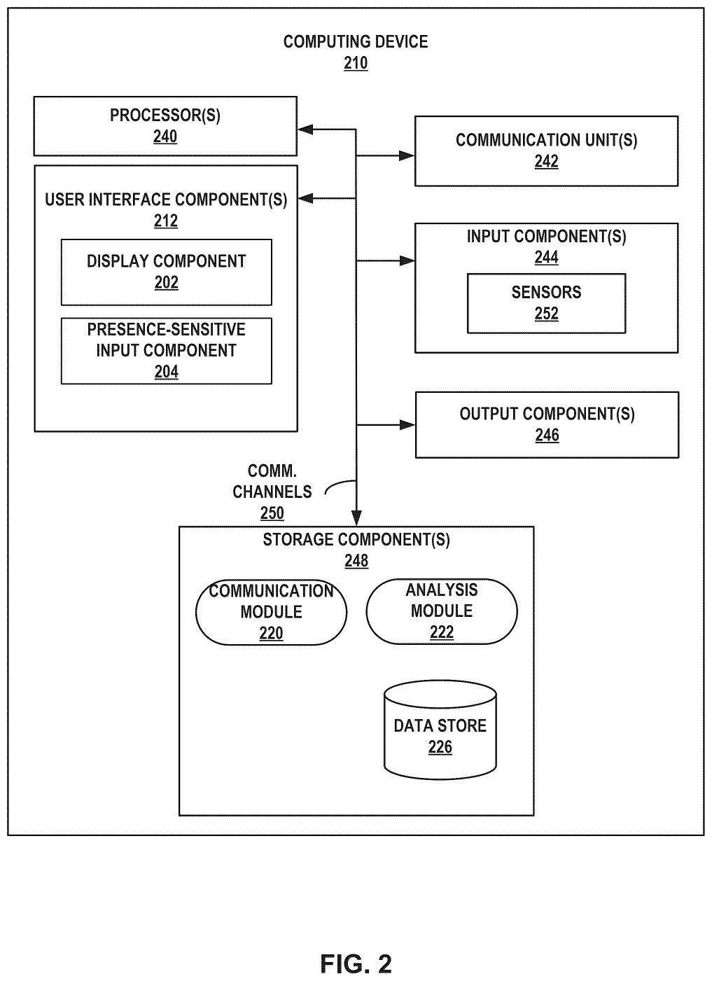

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to provide recommendations for physical books. That is, processors 240 may implement functionality and/or execute instructions associated with computing device 210 to capture images of physical books, identify the physical books, and provide personalized recommendations from that limited set of physical books identified in the image.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to capture images of physical books, identify the physical books, and provide personalized recommendations from that limited set of physical books identified in the image.

Communication module 220 may execute locally (e.g., at processors 240) to provide functions associated with controlling a camera to capture image and outputting graphical user interfaces. In some examples, communication module 220 may act as an interface to a remote service accessible to computing device 210. For example, communication module 220 may be an interface or application programming interface (API) to a remote server that controls a camera to capture image and outputs graphical user interfaces.

In some examples, analysis module 222 may execute locally (e.g., at processors 240) to provide functions associated with identifying the books within the capture images, analyzing those images to identify books within the images, and providing reader-based recommendations from that limited set of books identified in the images. In some examples, analysis module 222 may act as an interface to a remote service accessible to computing device 210. For example, analysis module 222 may be an interface or application programming interface (API) to a remote server that identifies the books within the capture images, analyzes those images to identify books within the images, and provides reader-based recommendations from that limited set of books identified in the images.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may control a camera, such as a camera integrated into computing device 210 or a camera separate from computing device 210 to capture one or more images of a plurality of physical books. Analysis module 222 may perform image analysis (e.g., optical character recognition, image matching, etc.) on the one or more images to identify each of the plurality of physical books. In some instances, in performing the image analysis, analysis module 222 may apply one or more artificial intelligence models to each of the one or more images to identify each of the plurality of books.

Analysis module 222 may access a reader preference profile of a user of the computing device. In some instances, the reader preference profile may include data indicative of one or more of a list of books the user previously read, a score for each of the books in the list of books, a set of genre preferences, rankings of books within the list of books or the set of genre preferences, author scores or rankings, price preferences, ratings in external reviews, a weight given to external reviews, book popularity, one or more emotional triggers, recent buying patterns, user demographics, a preferred time period the book was authored in, a time setting of the book, weights or rankings of other categories within the reader preference profile, and one or more preferable book characteristics, including any one or more of protagonist characteristics, plot characteristics, setting characteristics, theme characteristics, antagonist characteristics, supporting character characteristics, climax characteristics, point of view characteristics, conflict characteristics, length characteristics, art characteristics, and resolution characteristics, among other things

In some instances, the reader preference profile may include any one or more of one or more bibliographic characteristics, one or more quantitative attributes, one or more narrative content attributes, one or more pieces of contextual information, one or more book categorization attributes, one or more audiobook attributes, one or more eBook attributes, one or more statistical attributes, one or more marketing attributes, one or more community engagement attributes, one or more advanced literary and structural elements, one or more technical details, one or more digital metadata or technical tags, one or more academic attributes, one or more accessibility attributes, one or more localization or cultural sensitivity attributes, one or more post-release engagement metrics, one or more reader psychology or cognitive impact attributes, one or more narrative or character mechanic attributes, one or more experiential qualities, one or more cultural or social positioning attributes, one or more prestige attributes, one or more educational use characteristics, one or more utility attributes, one or more artificial intelligence or digital era attributes, and one or more philosophical attributes.

For the purposes of this disclosure, one or more bibliographic characteristics may include any one or more of title, subtitle, series title, series number, author(s), editor(s), translator(s), illustrator(s), publisher, publication date, country of publication, original language, current/translated language, International Standard Book Number (ISBN), edition number, printing number, copyright year, copyright holder, format (e.g., hardcover, paperback, ebook, audiobook), retail price, distributor, binding type, and cover design artist, among other things.

For the purposes of this disclosure, one or more quantitative attributes may include any one or more of page count, word count, chapter count, paragraph count, sentence count, average words per page, average sentence length, trim size/dimensions, weight, font type, font size, line spacing, margins, paper type (e.g., matte, glossy, recycled), ink color (e.g., black, colored text), number of illustrations, number of photographs, number of footnotes, number of endnotes, number of appendices, number of indexes, number of tables, number of charts, number of maps, number of references/sources, number of editions published, number of languages translated into, and number of reprints, among other things.

For the purposes of this disclosure, one or more narrative content attributes may include any one or more of genre, subgenre, theme(s), motifs, symbols, tone, mood, writing style (e.g., lyrical, sparse, academic), narration type (e.g., first person, third person limited, omniscient), tense (e.g., past, present, future), point of view (POV), main character(s), protagonist(s), antagonist(s), number of characters, supporting characters, flat or round characters, static or dynamic characters, character arcs, dialogue-heavy or narrative-heavy, pace (e.g., fast, slow, variable), setting—geographical, setting—temporal/time period, setting—cultural context, historical events referenced, flashbacks or non-linear structure, use of foreshadowing, allegorical elements, irony, satirical elements, use of figurative language, use of dialect/slang, philosophical or moral questions, societal critiques, archetypes, conflicts (e.g., internal/external), climax location, resolution type (e.g., open, closed), ending style (e.g., twist, tragic, happy, ambiguous), inciting incident, plot twists, story structure (e.g., three-act, hero's journey, nonlinear), subplots, chapter structure (e.g., episodic, flowing, cliffhangers), use of epigraphs or prologues, epilogue presence, use of multiple perspectives, language level (e.g., simple, advanced, poetic), and reading level, among other things.

For the purposes of this disclosure, one or more pieces of contextual information may include any one or more of author background, author's intent, historical context of writing, social/cultural commentary, political commentary, literary movement (e.g., modernism, romanticism), critical reception, awards received, book reviews, public controversies (if any), influence on culture, adaptations (e.g., film, play, series), influence from other works, dedication page content, acknowledgments, preface/introduction content, and foreword author (if present), among other things.

For the purposes of this disclosure, one or more book categorization attributes may include any one or more of Dewey Decimal classification, Library of Congress classification, genre tags (e.g., horror, sci-fi, romance), age category (e.g., children's, YA, adult), market category (e.g., trade, academic, mass market), audience demographic, trigger warnings (e.g., suicide, violence, sexual assault), content warnings, tropes used, fanbase size, fan-created content (e.g., fanfiction, art), Goodreads® rating, Amazon® rating, review count (e.g., Goodreads®, Amazon®, etc.), bestseller list placements, book club selections (e.g., Oprah's®, Reese's®, etc.), censorship/bans, cited in academic works, and school curriculum inclusion, among other things.

For the purposes of this disclosure, one or more audiobook attributes may include any one or more of audio book availability, narrator(s), length (hours/minutes), production company, number of voices (e.g., single, full cast), sound effects or music, audiobook awards, audiobook sample availability, and format (e.g., Audible, MP3, CD, etc.), among other things.

For the purposes of this disclosure, one or more eBook attributes may include any one or more of eBook availability, file format (e.g., ePub, MOBI, PDF), interactive elements (e.g., hyperlinks, media), DRM protection, accessibility features (e.g., text-to-speech, alt-text), font customization, adjustable background/contrast, page sync across devices, dictionary integration, note-taking features, and highlighting capabilities, among other things.

For the purposes of this disclosure, one or more statistical attributes may include any one or more of readability score (e.g., Flesch-Kincaid, etc.), sentiment analysis, vocabulary diversity, most frequent words, keyword density, reading time estimate, dialogue vs. narration ratio, gender ratio of characters, bechdel test pass/fail, diversity of characters (e.g., ethnicity, orientation, etc.), emotional range, plot complexity score, number of metaphors/similes, use of passive vs. active voice, average syllables per word, and word complexity score, among other things.

For the purposes of this disclosure, one or more marketing attributes may include any one or more of marketing campaign details, cover reveal events, launch date and strategy, book trailer availability, social media presence, book signing events, author interviews, merchandising, collector's editions, special editions (e.g., anniversary, illustrated, annotated), pre-order bonuses, Goodreads® giveaways, advance reader copies (ARCs), and book box inclusions (e.g., OwlCrate), among other things.

For the purposes of this disclosure, one or more community engagement attributes may include any one or more of book club questions, online discussion forums, fan theories, companion guides or workbooks, author q&a availability, read-alongs, study guides, SparkNotes®/CliffsNotes® availability, annotated editions, companion podcasts, reader demographics and stats, Goodreads® lists featuring the book, TikTok®/BookTok popularity, book memes or viral trends, fan translations, and parodies or inspired work, among other things.

For the purposes of this disclosure, one or more advanced literary and structural elements may include any one or more of use of unreliable narrator, metafiction elements (e.g., story about storytelling), breaking the fourth wall, intertextuality (e.g., references to other texts), stream of consciousness, pacing shifts (e.g., measured per act or chapter), foil characters, framing device (e.g., story within a story), unresolved plot threads, cliffhanger ending, presence of red herrings, reverse chronology, recursive narration (e.g., story loops), character-driven vs. plot-driven, dialogue tags style (e.g., “said,” “exclaimed,” etc.), visual poetry/layout (e.g., concrete poetry, shaped text), paratextual elements (e.g., notes, ads, marginalia, etc.), use of anachronism, authorial intrusion, symbolic naming (e.g., characters with metaphorical names), religious or mythological references, streamlined vs. fragmented narrative, real-time storytelling, use of lists or catalogs in prose, book's “voice” (e.g., narrative personality), and experimental grammar or punctuation, among other things.

For the purposes of this disclosure, one or more technical details may include any one or more of orphan/widow control in layout, kerning and letter spacing, hyphenation settings, use of ligatures in typography, paragraph indent vs. block formatting, number of proofing/editing passes, indexing method (e.g., manual vs. auto-generated), table of contents structure, custom typography/fonts used, embedded fonts in ebook formats, cover finish (matte, gloss, foil-stamped), embossing or debossing on cover, dust jacket presence and design, foil color used, spot uv on cover, endpaper color/design, gutter size (in physical books), printing method (e.g., offset, digital), print run size, printer location or company, environmental certifications (e.g., FSC paper), and bleed margins (for illustrated books), among other things.

For the purposes of this disclosure, one or more digital metadata or technical tags may include any one or more of metadata tags (e.g., title, author, subject, rights), DOI (for academic books), ASIN (Amazon® identifier), publisher's imprint (e.g., Tor, Knopf, etc.), BISAC codes (book industry subject headings), ONIX metadata (for book distribution), ePub version (2.0, 3.0, etc.), DRM scheme used (Adobe, Kindle, etc.), accessibility conformance (WCAG, EPUB A11Y), book preview availability, cross-referencing features (e.g., hyperlinked citations), watermark or digital fingerprinting (in DRM), page view vs. scroll reading mode, dictionary/in-text lookup compatibility, and embedded multimedia (in enhanced ebooks), among other things.

For the purposes of this disclosure, one or more academic attributes may include any one or more of citation format (e.g., APA, MLA, Chicago), indexing in academic databases (e.g., JSTOR, EBSCO), peer-reviewed status (for nonfiction), inclusion in syllabi or university curricula, number of academic citations, thesis/dissertation use, companion academic essays/articles, presence of footnotes vs. endnotes (structural choice), critical edition version (annotated for academic study), scholarly introduction or commentary, and glossary presence (for specialized terms), among other things.

For the purposes of this disclosure, one or more accessibility attributes may include any one or more of large print edition availability, dyslexia-friendly font availability, braille edition availability, captioned versions (e.g., for multimedia-enhanced ebooks), screen reader compatibility, text-to-speech optimization, color blindness-friendly design (e.g., contrast levels), simplified/abridged versions for neurodiverse readers, easy-read editions, gender-neutral language usage, inclusive representation metrics (e.g., race, gender, orientation), anti-stereotyping content analysis, and trigger/content note placement (beginning or end), among other things.

For the purposes of this disclosure, one or more localization or cultural sensitivity attributes may include any one or more of localized editions (e.g., British vs. American spelling), culturally adapted covers/titles, sensitivity reader involvement, translation fidelity score, translator's notes or preface, number of regional editions, idiom localization, language complexity adaptation per market, and visual localization (illustration redrawing), among other things.

For the purposes of this disclosure, one or more post-release engagement metrics may include any one or more of book return rates (retail), library check-out statistics, reread rate (percentage of readers who reread), average time to finish (per Goodreads® or Kindle), highlighted passages (Kindle or Kobo metrics), BookTube/BookTok review volume, book signing attendance, author social media mentions, review sentiment breakdown (positive/neutral/negative), average rating trajectory over time, pre-order vs. post-launch sales ratio, viral content reach (memes, quotes), and fan club or street team formation, among other things.

For the purposes of this disclosure, one or more reader psychology or cognitive impact attributes may include any one or more of emotional intensity (e.g., per scene or overall), cognitive load (e.g., complexity vs. ease of processing), empathy elicitation (e.g., how strongly readers relate to characters), persuasive techniques (e.g., especially in nonfiction), memory retention (e.g., memorable scenes or lines), “book hangover” potential, flow state facilitation (e.g., does it cause immersion?), psychological realism (e.g., accuracy of emotions/motivations), cognitive dissonance triggers, morality challenges posed to the reader, character relatability spectrum, philosophical depth, and spiritual or existential resonance, among other things.

For the purposes of this disclosure, one or more narrative or character mechanic attributes may include any one or more of number of character deaths, narrative reliability level, character diversity index (e.g., ethnicity, gender, class, ability, etc.), internal monologue frequency, dialogue vs. description ratio, number of POV shifts, use of diegesis (e.g., story told vs. shown), presence of meta-characters (aware they are in a story), generational span (e.g., multi-decade or ancestral arcs), character occupation diversity, relationship network complexity, love triangle or romantic subplot inclusion, representation of disabilities, representation of neurodivergence, and pet or animal character significance, among other things.

For the purposes of this disclosure, one or more experiential qualities may include any one or more of sensory language density (e.g., touch, smell, taste, etc.), visual layout complexity (e.g., for graphic novels or art books), use of synesthetic description, immersive world-building quality, atmosphere density (e.g., how “thick” the setting feels), time dilation (e.g., how time feels while reading), re-read value (e.g., increases or decreases over time), cross-sensory appeal (e.g., ASMR effect in audiobooks), and mood-dependent readability (e.g., best when sad, relaxed, etc.), among other things.

For the purposes of this disclosure, one or more cultural or social positioning attributes may include any one or more of book's ideology or political leaning, countercultural or subversive qualities, social justice themes, intersectionality representation, censorship status in specific countries, cultural taboos addressed, media literacy elements (e.g., for modern/YA readers), dialogue with contemporary issues (e.g., climate change, AI), commentary on capitalism, race, gender, etc., literary activism (e.g., pro-immigration, anti-racist themes), and inclusivity rating (e.g., LGBTQ+, BIPOC, non-Western), among other things.

For the purposes of this disclosure, one or more prestige attributes may include any one or more of author's literary reputation, canonical status (e.g., is it considered a classic?), cited in other works (e.g., intertextuality presence), literary criticism written about it, included in “100 books to read before you die” lists, collected works inclusion (e.g., in anthologies, series), comparative importance to author's body of work, ephemeral vs. enduring cultural impact, first editions' rarity or collectability, availability in special collections/libraries, and historical firsts (e.g., first sci-fi book written by X group), among other things.

For the purposes of this disclosure, one or more educational use characteristics may include any one or more of use in standardized test prep (e.g., SAT, ACT, AP Lit), availability in school districts (e.g., banned or supported), adaptability for discussion-based teaching, lesson plan availability, pedagogical value (e.g., supports critical thinking), cognitive developmental alignment (e.g., Piaget's stages), supplementary workbook inclusion, annotations for classroom use, question bank existence for quizzes/tests, and alignment with Common Core or other educational standards, among other things.

For the purposes of this disclosure, one or more utility attributes may include any one or more of journal/interactive hybrid format (e.g., “Wreck This Journal”), puzzle-solving or gamified elements, reference vs. narrative format, indexing quality (e.g., for research use), use of citation or footnote systems, margin space for notes (e.g., reader interaction), reusability (e.g., cookbooks, planners, etc.), standalone vs. part of a curriculum or package, companion app or website, and book-linked online community or forum, among other things.

For the purposes of this disclosure, one or more artificial intelligence or digital era attributes may include any one or more of AI-generated or AI-assisted content, availability in large-language model datasets, availability on BookGPT or other AI summary tools, rights management for AI training, ethical stance on digital consumption, NFT/book token version, blockchain publishing traceability, AI audiobook narration quality vs. human, and inclusion in AI recommender systems (e.g., Spotify® for books-type apps), among other things.

For the purposes of this disclosure, one or more philosophical attributes may include any one or more of exploration of paradoxes, meta-narrative or existential commentary, treatment of taboo or sacred themes, questions of fate vs. free will, depictions of moral ambiguity, use of silence or absence as a literary device, concept of truth vs. narrative, mythopoeia (e.g., creation of fictional mythologies), time perception (e.g., cyclical, fragmented, infinite), cosmology/worldview embedded in the book, and existential threat levels (e.g., personal vs. species-wide), among other things.

In some instances, in accessing the reader preference profile, communication module 220 may output, to the output component, one or more prompts in a second graphical user interface. In some instances, the prompts may be asking specific book-related questions, wherein other instances could include only a prompt of a verification that the user is a human. Communication module 220 may receive one or more indications of user input providing a response to each of the one or more prompts. Analysis module 222 may develop the reader preference profile based on the one or more responses. In some instances, the one or more prompts each comprise an inquiry into what the user is currently wanting to read or books that the user has read in the past.

The process of the system prompting the user to answer questions to build the reader preference profile is designed to be interactive, adaptive, and user-friendly. When a user first engages with the system, such as upon initial setup, after scanning a new set of physical books, or when the system detects insufficient profile data, computing device 210 initiates a guided question-and-answer session through a graphical user interface (GUI).

Initially, the system may present a welcome message or brief explanation of how personalized recommendations are generated. The user is then presented with a series of prompts, which may include multiple-choice questions, sliders, checkboxes, or open-ended text fields. Example prompts include:
“What genres are you most interested in right now?” (with options such as mystery, science fiction, biography, etc.)
“Are there any topics or themes you would like to avoid?” (with options for common triggers such as violence, romance, or tragedy)
“How important are external reviews or ratings to your book selection?” (with a slider or ranking scale)
“What is your preferred book length?” (with options for short, medium, or long)
“Are you looking for a light read or something more challenging?”
“Would you like to see recommendations based on books you've enjoyed in the past?”

As the user responds, the system dynamically updates the reader preference profile, storing the user's selections, preferences, and any specified trigger warnings. The system may also ask follow-up questions based on previous answers to further refine the profile. For example, if a user selects “science fiction,” the system might ask about preferred subgenres or favorite authors.

The system is designed to minimize user effort and can allow the user to skip questions or provide responses at their own pace. In some implementations, the system may also analyze the user's reading history, imported book lists, or previous feedback to supplement the profile without requiring additional input.

Once sufficient information is gathered, the system finalizes the reader preference profile and uses it to generate personalized recommendation scores for the physical books identified in the user's environment. The user can update or refine their profile at any time, and the system may periodically prompt for new input to keep recommendations relevant as the user's tastes evolve.

This interactive process ensures that the reader preference profile accurately reflects the user's current interests, sensitivities, and priorities, enabling the system to deliver highly relevant and personalized book recommendations.

Analysis module 222 may determine, based at least in part on the reader preference profile, a recommendation score for each of the plurality of physical books. In some instances, in determining the recommendation score, for each of the plurality of physical books, analysis module 222 may identify, using an artificial intelligence model, one or more characteristics of the respective physical book. The one or more characteristics may include any one or more of a title of the first physical book, one or more external reviews for the first physical book, rationale for the recommendation score of the first physical book, typical price of the first physical book, a summary of the first physical book, a date of the first physical book being written, a page count of the first physical book, and a price for a copy of the physical book at an alternate location. The artificial intelligence model may be trained by accessing some or all data publicly available that may be descriptive of the various books identified. Analysis module 222 may compare the one or more characteristics of the respective physical book to the reader preference profile of the user. Analysis module 222 may generate the recommendation score for the respective physical book based on one or more of a likelihood that the user would positively rate the respective physical book or a predicted rating that the user would give the respective physical book upon reading the respective physical book.

In some instances where the reader preference profile includes the one or more trigger warnings, determining the recommendation score may include determining whether the respective physical book in the plurality of physical books includes a prompting event which would elicit an emotional reaction due to the one or more emotional triggers of the user. This could include any number of common emotional triggers, including sexual assault, pregnancy loss, crime, murder, drug use, alcohol use, parent or child death, or any other emotional trigger. In response to determining that the respective book includes the prompting event which would elicit the emotional reaction due to the one or more emotional triggers of the user, analysis module 222 may adjust the recommendation score for the respective physical book to be lower. In some instances, communication module 220 may additionally output, to the output component, a graphical indication of a trigger warning in a second graphical user interface whenever the second graphical user interface includes a graphical indication of the respective book that includes the prompting event which would elicit the emotional reaction due to the one or more emotional triggers of the user.

Analysis module 222 may determine a first physical book of the plurality of physical books that has a highest recommendation score compared to each other recommendation score for each other physical book of the plurality of physical books. Analysis module 222 may generate a graphical user interface including at least a graphical indication of the first physical book. Communication module 220 may output, to an output component, the graphical user interface.

In some instances, analysis module 222 may further sort the plurality of physical books into a sorted list based on the recommendation score for each of the plurality of physical books. The graphical user interface includes at least a portion of the sorted list.

In some instances, communication module 220 may receive an indication of user input selecting the graphical indication of the first physical book. Analysis module 222 may update the graphical user interface to include one or more characteristics of the first physical book. Additionally or alternatively, communication module 220 may receive feedback evaluating the first physical book. Analysis module 222 may update the reader profile preference based on the feedback evaluating the first physical book.

In some instances, analysis module 222 may determine, based at least in part on the reader profile preferences, at least one recommendation score for a book not present in the plurality of physical books.

In some instances, such as in a library or other location where there are more books than can reasonably fit in a single image, communication module 220 may cause the camera to capture a plurality of images. Analysis module 222 may perform the image analysis on each of the plurality of images, and a single list of book recommendations may be made from the list of every book found in any of the plurality of images.

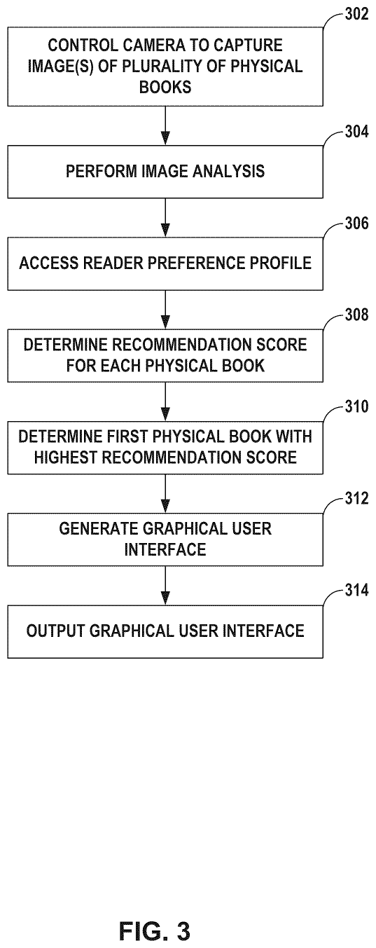

FIG. 3 is a flow chart illustrating an example mode of operation. The techniques of FIG. 3 may be performed by one or more processors of a computing device, such as system 100 of FIG. 1 and/or computing device 210 illustrated in FIG. 2. For purposes of illustration only, the techniques of FIG. 3 are described within the context of computing device 210 of FIG. 2, although computing devices having configurations different than that of computing device 210 may perform the techniques of FIG. 3.

In accordance with the techniques of this disclosure, communication module 220 controls a camera to capture one or more images of a plurality of physical books (302). Analysis module 222 performs image analysis on the one or more images to identify each of the plurality of physical books (304). Analysis module 222 accesses a reader preference profile of a user of the computing device (306). Analysis module 222 determines, based at least in part on the reader preference profile, a recommendation score for each of the plurality of physical books (308). Analysis module 222 determines a first physical book of the plurality of physical books that has a highest recommendation score compared to each other recommendation score for each other physical book of the plurality of physical books (310). Analysis module 222 generates a graphical user interface including at least a graphical indication of the first physical book (312). Communication module 220 outputs, to an output component, the graphical user interface (314).

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
controlling, by one or more processors of a computing device, a camera to capture one or more images of a plurality of physical books;
performing, by the one or more processors, image analysis on the one or more images to identify each of the plurality of physical books;
accessing, by the one or more processors, a reader preference profile of a user of the computing device;
determining, by the one or more processors and based at least in part on the reader preference profile, a recommendation score for each of the plurality of physical books;
determining, by the one or more processors, a first physical book of the plurality of physical books that has a highest recommendation score compared to each other recommendation score for each other physical book of the plurality of physical books;
generating, by the one or more processors, a graphical user interface including at least a graphical indication of the first physical book; and
outputting, by the one or more processors and to an output component, the graphical user interface.

2. The method of claim 1, wherein performing the image analysis comprises applying, by the one or more processors, one or more artificial intelligence models to each of the one or more images to identify each of the plurality of books.

3. The method of claim 1, wherein accessing the reader preference profile comprises:
outputting, by the one or more processors and to the output component, one or more prompts in a second graphical user interface;
receiving, by the one or more processors, one or more indications of user input providing a response to each of the one or more prompts; and
developing, by the one or more processors, the reader preference profile based on the one or more responses.

4. The method of claim 3, wherein the one or more prompts each comprise an inquiry into what the user is currently wanting to read.

5. The method of claim 1, wherein the reader preference profile comprises data indicative of one or more of:
one or more bibliographic characteristics,
one or more quantitative attributes,
one or more narrative content attributes,
one or more pieces of contextual information,
one or more book categorization attributes,
one or more audiobook attributes,
one or more eBook attributes,
one or more statistical attributes,
one or more marketing attributes,
one or more community engagement attributes,
one or more advanced literary and structural elements,
one or more technical details,
one or more digital metadata or technical tags,
one or more academic attributes,
one or more accessibility attributes,
one or more localization or cultural sensitivity attributes,
one or more post-release engagement metrics,
one or more reader psychology or cognitive impact attributes,
one or more narrative or character mechanic attributes,
one or more experiential qualities,
one or more cultural or social positioning attributes,
one or more prestige attributes,
one or more educational use characteristics,
one or more utility attributes,
one or more artificial intelligence or digital era attributes, and
one or more philosophical attributes.

6. The method of claim 1, wherein the reader preference profile includes one or more trigger warnings, wherein determining the recommendation score comprises:
determining, by the one or more processors, whether the respective physical book in the plurality of physical books includes a prompting event which would elicit an emotional reaction due to the one or more emotional triggers of the user; and
in response to determining that the respective book includes the prompting event which would elicit the emotional reaction due to the one or more emotional triggers of the user, adjusting, by the one or more processors, the recommendation score for the respective physical book to be lower.

7. The method of claim 6, further comprising:
outputting, by the one or more processors and to the output component, a graphical indication of a trigger warning in a second graphical user interface whenever the second graphical user interface includes a graphical indication of the respective book that includes the prompting event which would elicit the emotional reaction due to the one or more emotional triggers of the user.

8. The method of claim 1, wherein determining the recommendation score comprises, for each of the plurality of physical books:
identifying, by the one or more processors and using an artificial intelligence model, one or more characteristics of the respective physical book;
comparing, by the one or more processors, the one or more characteristics of the respective physical book to the reader preference profile of the user; and
generating, by the one or more processors, the recommendation score for the respective physical book based on one or more of a likelihood that the user would positively rate the respective physical book or a predicted rating that the user would give the respective physical book upon reading the respective physical book.

9. The method of claim 1, further comprising:
sorting, by the one or more processors, the plurality of physical books into a sorted list based on the recommendation score for each of the plurality of physical books,
wherein the graphical user interface includes at least a portion of the sorted list.

10. The method of claim 1, further comprising:
receiving, by the one or more processors, an indication of user input selecting the graphical indication of the first physical book; and
updating, by the one or more processors, the graphical user interface to include one or more characteristics of the first physical book.

11. The method of claim 10, wherein the one or more characteristics include any one or more of:
a title of the first physical book,
one or more external reviews for the first physical book,
rationale for the recommendation score of the first physical book,
typical price of the first physical book,
a summary of the first physical book,
a date of the first physical book being written,
a page count of the first physical book, and
a price for a copy of the physical book at an alternate location.

12. The method of claim 10, further comprising:
receiving, by the one or more processors, feedback evaluating the first physical book; and
updating, by the one or more processors, the reader profile preference based on the feedback evaluating the first physical book.

13. The method of claim 1, further comprising:
determining, by the one or more processors and based at least in part on the reader profile preferences, at least one recommendation score for a book not present in the plurality of physical books.

14. A system comprising:
one or more processors;
a camera operably coupled to the one or more processors and configured to capture one or more images of a plurality of physical books;
a memory operably coupled to the one or more processors and storing instructions that, when executed by the one or more processors, cause the system to:
perform image analysis on the one or more images to identify each of the plurality of physical books;
access a reader preference profile of a user of the system;
determine, based at least in part on the reader preference profile, a recommendation score for each of the plurality of physical books;
determine a first physical book of the plurality of physical books that has a highest recommendation score compared to each other recommendation score for each other physical book of the plurality of physical books;
generate a graphical user interface including at least a graphical indication of the first physical book; and
output the graphical user interface to an output component.

15. The system of claim 1, wherein performing the image analysis comprises applying one or more artificial intelligence models to each of the one or more images to identify each of the plurality of physical books.

16. The system of claim 1, wherein accessing the reader preference profile comprises:
outputting, by the one or more processors and to the output component, one or more prompts in a second graphical user interface;
receiving one or more indications of user input providing a response to each of the one or more prompts; and
developing the reader preference profile based on the one or more responses.

17. The system of claim 1, wherein the reader preference profile includes one or more trigger warnings, and wherein determining the recommendation score comprises:
determining whether a respective physical book in the plurality of physical books includes a prompting event which would elicit an emotional reaction due to the one or more emotional triggers of the user; and
in response to determining that the respective book includes the prompting event which would elicit the emotional reaction due to the one or more emotional triggers of the user, adjusting the recommendation score for the respective physical book to be lower.

18. The system of claim 1, wherein determining the recommendation score comprises, for each of the plurality of physical books:
identifying, using an artificial intelligence model, one or more characteristics of the respective physical book;
comparing the one or more characteristics of the respective physical book to the reader preference profile of the user; and
generating the recommendation score for the respective physical book based on one or more of a likelihood that the user would positively rate the respective physical book or a predicted rating that the user would give the respective physical book upon reading the respective physical book.

19. The system of claim 1, wherein the instructions, when executed by the one or more processors, further cause the one or more processors to:
sort the plurality of physical books into a sorted list based on the recommendation score for each of the plurality of physical books,
wherein the graphical user interface includes at least a portion of the sorted list.

20. A non-transitory computer-readable storage medium having instructions stored thereon that, when executed by one or more processors of a computing device, cause the computing device to:
control a camera to capture one or more images of a plurality of physical books;
perform image analysis on the one or more images to identify each of the plurality of physical books;
access a reader preference profile of a user of the computing device;
determine, based at least in part on the reader preference profile, a recommendation score for each of the plurality of physical books;
determine a first physical book of the plurality of physical books that has a highest recommendation score compared to each other recommendation score for each other physical book of the plurality of physical books;
generate a graphical user interface including at least a graphical indication of the first physical book; and
output the graphical user interface to an output component.
